(19) United States
(12) Patent Application Publication
(10) Pub. No.: US 2013/0018974 A1
(43) Pub. Date: Jan. 17, 2013

(54) COMMUNICATION TERMINAL APPARATUS, EMAIL CREATING METHOD AND RECORDING MEDIUM

(71) Applicants: Hiroshi Itani, Osaka-shi (JP); Yoshiaki Sumida, Osaka-shi (JP)

(72) Inventors: Hiroshi Itani, Osaka-shi (JP); Yoshiaki Sumida, Osaka-shi (JP)

(73) Assignee: SHARP KABUSHIKI KAISHA, Osaka-shi, Osaka (JP)

(21) Appl. No.: 13/637,307

(22) PCT Filed: Apr. 25, 2011
(86) PCT No.: PCT/JP2011/060013

§ 371 Date: Sep. 25, 2012

(30) Foreign Application Priority Data
May 10, 2010 (JP) 2010-108173

(51) Int. Cl. G06F 15/16

(52) U.S. Cl. 709/206

(57) ABSTRACT

This invention is directed to provision of a communication terminal apparatus that allows a reply email to be created by a simple operation without interrupting a current email creating process in a case where the remaining battery charge has been reduced during the email creating process. The communication terminal apparatus comprising: a communicating portion for sending/receiving a mail; a displaying portion; a storage portion that a preliminarily created power reducing message registered; a character string editing portion for displaying characters input by an input portion and conversion candidates of the characters on the displaying portion; a predictive conversion controlling portion for acquiring conversion candidates corresponding to characters input to the character string editing portion; and a remaining battery charge determining portion for determining a state of a remaining battery charge, wherein the predictive conversion controlling portion acquires and adds the power reducing message from the storage portion to conversion candidates if the remaining battery charge determining portion determines that a remaining battery charge level is equal to or less than a first prescribed value.

### TECHNICAL FIELD

The present invention relates to a communication terminal apparatus and specifically to a communication terminal apparatus having a mail transmission function.

### BACKGROUND OF THE INVENTION

Portable telephones of recent years have a function enabling immediate transmission of a reply mail with simple operation when one wants to immediately send a reply to a received mail while on the move or at work.

For example, portable telephones have a quick reply function. In this quick reply function, when predetermined operation is performed on a screen displaying a received mail, a list of prepared fixed phrases for a reply (e.g., “I understand.”, “I'm on the move now”) is displayed on the screen and if an operator selects a fixed phrase corresponding to the content of the received mail, a reply mail with the fixed phrase input is transmitted. This quick reply function enables immediate transmission of a reply mail with simple operation.

For example, Patent Document 1 proposes a portable telephone in which when a mail is received, a preliminarily registered sentence is displayed by pressing down a certain button for a predetermined time and can be selected to transmit a mail.

Since the portable telephone according to Patent Document 1 enables immediate transmission of a reply mail with simple operation, if a remaining battery charge of the portable telephone is low at the time of reception of a mail, a reply mail can be sent before the battery of the portable telephone runs out.

### PRIOR ART DOCUMENT

### Patent Document

### Patent Document 1: Japanese Laid-Open Patent Publication No. 2005-20613

### SUMMARY OF THE INVENTION

### Problem to be Solved by the Invention

However, if it is attempted to use the function when the remaining battery charge becomes very small while a mail is created with the portable telephone according to Patent Document 1, the creation of the mail must once be terminated to perform a predetermined operation utilizing incoming call history, etc., which is cumbersome.

Therefore, it is an object of the present invention to provide a communication terminal apparatus in which a reply mail can be crated with simple operation without interrupting a mail creating process when a remaining battery charge becomes low while a mail is created.

### Means for Solving the Problem

To solve the above problems, a first technical means of the present invention is a communication terminal apparatus comprising: a communicating portion for sending/receiving a mail; a displaying portion; a storage portion that a preliminarily created power reducing message registered; a character string editing portion for displaying characters input by an input portion and conversion candidates of the characters on the displaying portion; a predictive conversion controlling portion for acquiring conversion candidates corresponding to characters input to the character string editing portion; and a remaining battery charge determining portion for determining a state of a remaining battery charge, wherein the predictive conversion controlling portion acquires and adds the power reducing message from the storage portion to conversion candidates if the remaining battery charge determining portion determines that a remaining battery charge level is equal to or less than a first prescribed value.

A second technical means is the communication terminal apparatus of the first technical means, wherein a plurality of the power reducing messages is registered in the storage portion, and the predictive conversion controlling portion acquires and adds a plurality of power reducing messages to conversion candidates.

A third technical means is the communication terminal apparatus of the first or the second technical means, wherein when an operator selects and determines the power reducing message from the conversion candidates, the character string editing portion deletes characters that are being edited in the character string editing portion and displays the power reducing message on the displaying portion.

A fourth technical means is the communication terminal apparatus of any one of the first to the third technical means, wherein the remaining battery charge determining portion determines that it is low remaining charge if the remaining battery charge level is equal to or lower than the first prescribed value and determines that it is medium remaining charge if the remaining battery charge level is greater than the first prescribed value and equal to or less than a second prescribed value, and the predictive conversion controlling portion defines the power reducing message as a first candidate of the conversion candidates if a remaining battery charge corresponds to the low remaining charge and defines the power reducing message as a second or later candidate of the conversion candidates if a remaining battery charge corresponds to the medium remaining charge.

A fifth technical means is the communication terminal apparatus of anyone of the second to the fourth technical means, further comprising a document analyzing portion for analyzing a text that is being edited in the character string editing portion, wherein the document analyzing portion analyzes a sentence form from the end of a sentence in a document displayed in the character string editing portion and notifies the predictive conversion controlling portion of an analysis result as a document input form, and when the document input form is notified, the predictive conversion controlling portion acquires the power reducing message corresponding to the document input form.

A sixth technical means is the communication terminal apparatus of any one of the second to the fifth technical means, further comprising a parameter setting portion for setting a selection reference parameter acting as a selection reference when a power reducing message is extracted from a plurality of power reducing messages, and a term dictionary for managing terms related to the selection reference parameter, wherein if the selection reference parameter is set, the predictive conversion controlling portion acquires terms related to the selection reference parameter from the term dictionary and acquires a power reducing message including the terms.

A seventh technical means is the communication terminal apparatus of any one of the second to the fifth technical means, further comprising a parameter setting portion for setting a selection reference parameter acting as a selection reference when a power reducing message is extracted from a plurality of power reducing messages, wherein the power reducing messages are registered in the storage portion in correlation with the selection reference parameter, and if the selection reference parameter is set, the predictive conversion controlling portion acquires a power reducing message correlated with the selection reference parameter.

An eighth technical means is an email creating method used in a communication terminal apparatus comprising: a communicating portion for sending/receiving a mail; a displaying portion; a storage portion that a preliminarily created power reducing message registered; a character string editing portion for displaying characters input by an input portion and conversion candidates of the characters on the displaying portion; a predictive conversion controlling portion for acquiring conversion candidates corresponding to characters input to the character string editing portion; and a remaining battery charge determining portion for determining a state of a remaining battery charge, wherein the predictive conversion controlling portion acquires and adds the power reducing message from the storage portion to conversion candidates if the remaining battery charge determining portion determines that a remaining battery charge level is lower than a prescribed value.

A ninth technical means is an email creating program run on a computer to implement the email creating method of the eighth technical means.

### Effect of the Invention

According to the present invention, when the remaining battery charge determining portion determines that a remaining battery charge level is lower than prescription while a mail is created, the predictive conversion controlling portion acquires and adds a preliminarily created power reducing message to conversion candidates. Therefore, an operator can select the power reducing message to create a reply mail with simple operation without interrupting a mail creating process.

### BRIEF DESCRIPTION OF DRAWINGS

FIG. 1 is an external view of a portable telephone according to the present invention.

FIG. 2 is a block diagram of the portable telephone according to the present invention.

FIG. 3 is a flowchart of a remaining battery charge determining portion.

FIG. 4 is a flowchart of a predictive conversion controlling portion.

FIG. 5 is a screen transition diagram when a remaining battery charge is greater than a first prescribed value.

FIG. 6 is a screen transition diagram when a battery is in a power reducing state.

FIG. 7 is a flowchart of another process pattern of the remaining battery charge determining portion.

FIG. 8 is a flowchart of another process pattern of the predictive conversion controlling portion.

FIG. 9 is a flowchart of the remaining battery charge determining portion.

FIG. 10 is a flowchart of the predictive conversion controlling portion.

FIG. 11 is a screen transition diagram of a process of registering a plurality of power reducing messages.

FIG. 12 is a diagram of how the power reducing message corresponding to a document input form is displayed.

FIG. 13 is a diagram of how the power reducing message corresponding to a parameter is displayed.

FIG. 14 is a diagram of how the power reducing message corresponding to a parameter is displayed.

FIG. 15 is a diagram of how a candidate position is changed in display depending on a remaining battery charge.

FIG. 16 is a diagram of how an adjustment process of a mail body text is executed.

### PREFERRED EMBODIMENT OF THE INVENTION

### First Embodiment

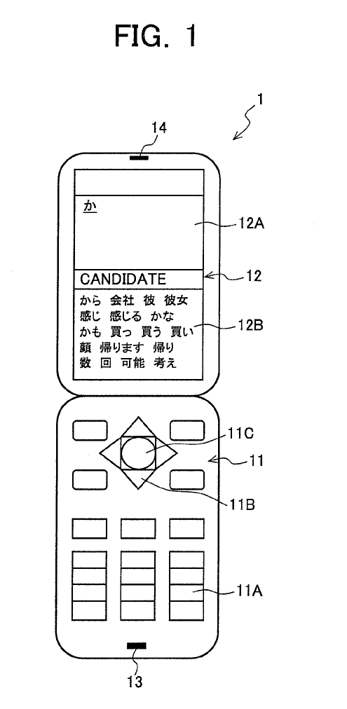

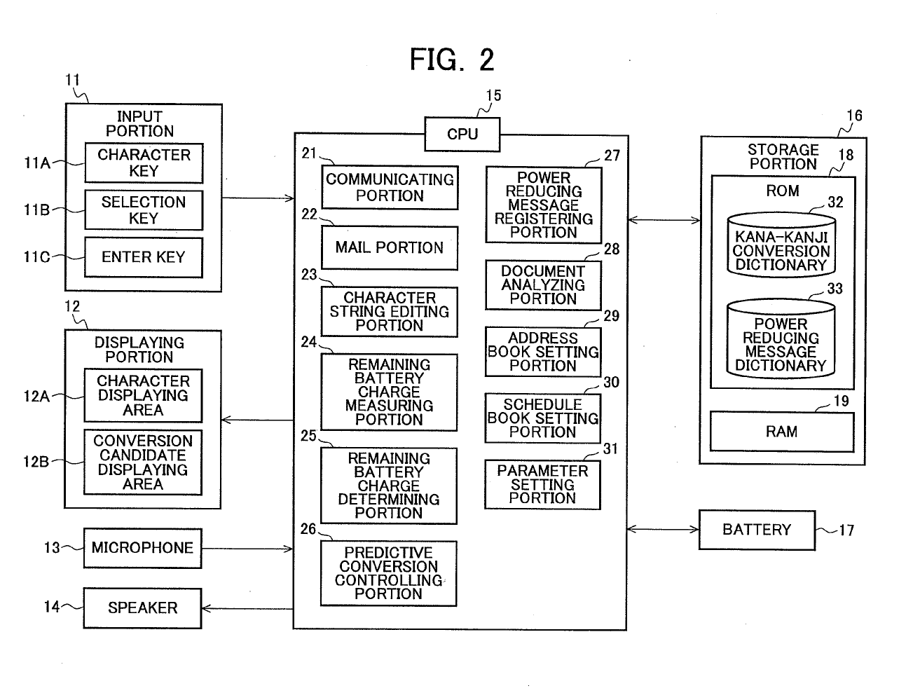

A portable telephone 1, i.e., a communication terminal apparatus according to a first embodiment of the present invention, will be described with reference to FIGS. 1 and 2. FIG. 1 is an external view of the portable telephone 1. FIG. 2 is a block diagram of a configuration of the portable telephone 1.

As depicted in FIG. 1, the portable telephone 1 has an input portion 11, a displaying portion 12, a microphone portion 13, and a speaker portion 14. As depicted in FIG. 2, the portable telephone 1 has a CPU 15, a storage portion 16, and a battery 17 along with those described with reference to FIG. 1.

The input portion 11 has character keys 11A, selecting keys 11B, an enter key 11C, etc. A plurality of character keys 11A is disposed to enable the input of a telephone number, the character input of electric mail, etc. The selecting keys 11B can be used for moving a cursor on a list displayed on the displaying portion 12 to select an item. The enter key 11C is used to confirm the item selected by moving the cursor with the selecting keys 11B. The input portion 11 may be implemented by using a touch panel.

The displaying portion 12 has a screen vertically divided during input of a text of electric mail etc., as depicted in FIG. 1. The displaying portion 12 displays a character displaying area 12A on the upper stage and displays a conversion candidate displaying area 12B on the lower stage. The character displaying area 12A displays a character string input with the character keys 11A during input of a text and a text created by character conversion of the character string. The conversion candidate displaying area 128 is displayed as needed and can display conversion candidates of a character string input with the character keys 11A. The displaying portion 12 is made up of a liquid crystal panel and an organic EL panel, for example.

The microphone 13 transmits voice during a telephone call. The speaker 14 receives voice during a telephone call.

The storage portion 16 is made up of a memory such as a ROM 18 and a RAM 19. The ROM 18 includes a flash EEPROM and stores various data and programs. The ROM 18 stores a kana-kanji conversion dictionary 32 managing conversion candidate information and a power reducing message dictionary 33 storing power reducing messages. The RAM 19 temporarily stores various data and is used as a work area.

The battery 17 supplies electric power to the portions of the portable telephone 1.

The CPU 15 is a central processing unit acting as a controlling means comprehensively controlling the main body of the portable telephone 1. The CPU is a kind of computer driving the programs stored in the ROM 32 to be read and executed. The functions of the CPU 15 include a communicating portion 21, a mail portion 22, a character string editing portion 23, a remaining battery charge measuring portion 24, a remaining battery charge determining portion 25, a predictive conversion controlling portion 26, a power reducing message registering portion 27, a document analyzing portion 28, an address book setting portion 29, a schedule book setting portion 30, and a parameter setting portion 31.

The communicating portion 21 communicates with a base station to send/receive a phone call and a mail.

The mail portion 22 can create a mail and can transmit/receive a mail via the communicating portion 21. A body text of a mail is created by activating the character string editing portion 23.

The character string editing portion 23 is activated when a body text of a mail is created by the mail portion 22, and can display and edit characters input by the input portion 11 on the displaying portion 12. When characters are input with the character keys 11A, the character string editing portion 23 notifies the predictive conversion controlling portion 26 of the character information. This notification will hereinafter be referred to as a character information notification. When receiving from the predictive conversion controlling portion 26 a conversion candidate acquisition notification indicating that conversion candidates are acquired, the character string editing portion 23 displays conversion candidates retained on the RAM 19 in the conversion candidate displaying area 12B of the displaying portion 12.

The remaining battery charge measuring portion 24 periodically measures a remaining battery charge with a known means and notifies the remaining battery charge determining portion 25 to indicate that a remaining battery charge is measured. The remaining battery charge measuring portion 24 retains a measured remaining battery charge level on the RAM 19.

The remaining battery charge determining portion 25 reads the remaining battery charge level stored on the RAM 19 in accordance with a predetermined condition. The remaining battery charge determining portion 25 determines that a level of the remaining battery charge is a low remaining charge if the remaining battery charge level is equal to or less than a first prescribed value, determines that a level of the remaining battery charge is a medium remaining charge if the remaining battery charge level is greater than the first prescribed value and equal to or less than a second prescribed value, and determines that a level of the remaining battery charge is a high remaining charge if the remaining battery charge level is greater than the second prescribed value. The remaining battery charge determining portion 25 reports the remaining battery charge level to the predictive conversion controlling portion 26 through a battery state notification. Although a method of reporting to the predictive conversion controlling portion 26 through the battery state notification has been described, this is not a limitation and the report may be made through a power reducing state flag indicting that a remaining battery charge is equal to or less than the first prescribed value.

The predictive conversion controlling portion 26 is activated in accordance with the activation of the character string editing portion 23. When the character information notification is performed by the character string editing portion 23, the predictive conversion controlling portion 26 acquires and retains conversion candidates corresponding to this notification on the RAM 19 and notifies the character string editing portion 23 to indicate that the conversion candidates are acquired. This notification will hereinafter be referred to as a conversion candidate acquisition notification. If the level of the remaining battery charge turns to the low remaining charge or the medium remaining charge, the predictive conversion controlling portion 26 adds a preliminarily created power reducing message to the conversion candidates. The power reducing message is a preliminarily created text telling that a response to a received mail cannot immediately be made because a remaining battery charge is few.

The power reducing message registering portion 27 can register a power reducing message to the power reducing message dictionary 33. The power reducing message registering portion 27 can register a power reducing message in correlation with a power reducing message selection reference parameter described later.

The document analyzing portion 28 identifies a position of a comma in a text being edited by the character string editing portion 23. The document analyzing portion 28 determines whether a “desu/masu style” is used before the comma and, if the “desu/masu style” is used before the comma of the text being edited, the document analyzing portion 28 gives a document input form notification to the predictive conversion controlling portion 26 to indicate that the text input state is in a desu/masu style state.

The address book setting portion 29 can set a mail address, a telephone number, and a genre for each registrant. Friend, business, etc., can be set as a genre.

The schedule book setting portion 30 can set a schedule for each day. For example, an outing, a travel, etc., can be set.

The parameter setting portion 31 can set a power reducing message selection reference parameter. The power reducing message selection reference parameter acts as a selection reference when a power reducing message corresponding to the power reducing message selection reference parameter is extracted from a plurality of power reducing messages. For example, “time”, “business”, “friend”, “outing”, and “travel” can be set as the power reducing message selection reference parameter.

The storage portion 16 stores a term dictionary (not depicted) managing terms related to the selection reference parameter. When the power reducing message selection reference parameter is given and set, the predictive conversion controlling portion 26 acquires terms related to the power reducing message selection reference parameter from the term dictionary. For example, if “time” is set as the selection reference parameter, the predictive conversion controlling portion 26 acquires terms related to “time”, for example, “morning/daytime/night/noon/hour/minute . . . ” from the term dictionary. The predictive conversion controlling portion 26 extracts a power reducing message including the acquired terms from a plurality of power reducing messages.

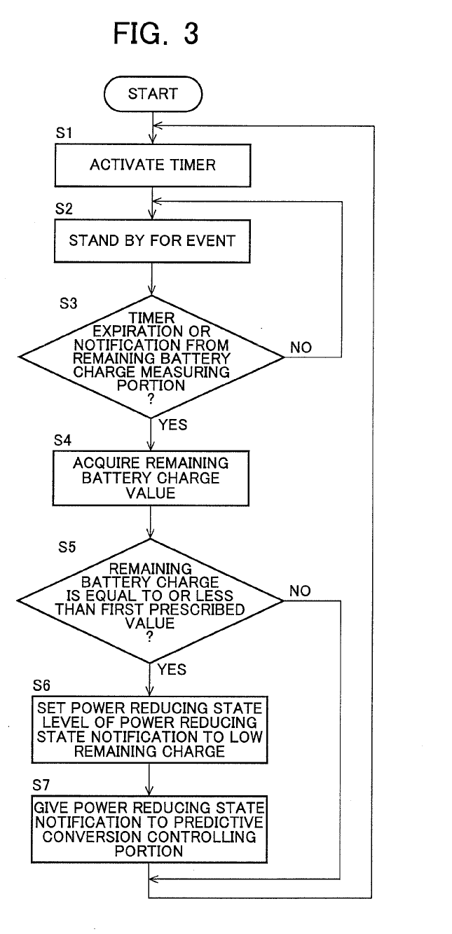

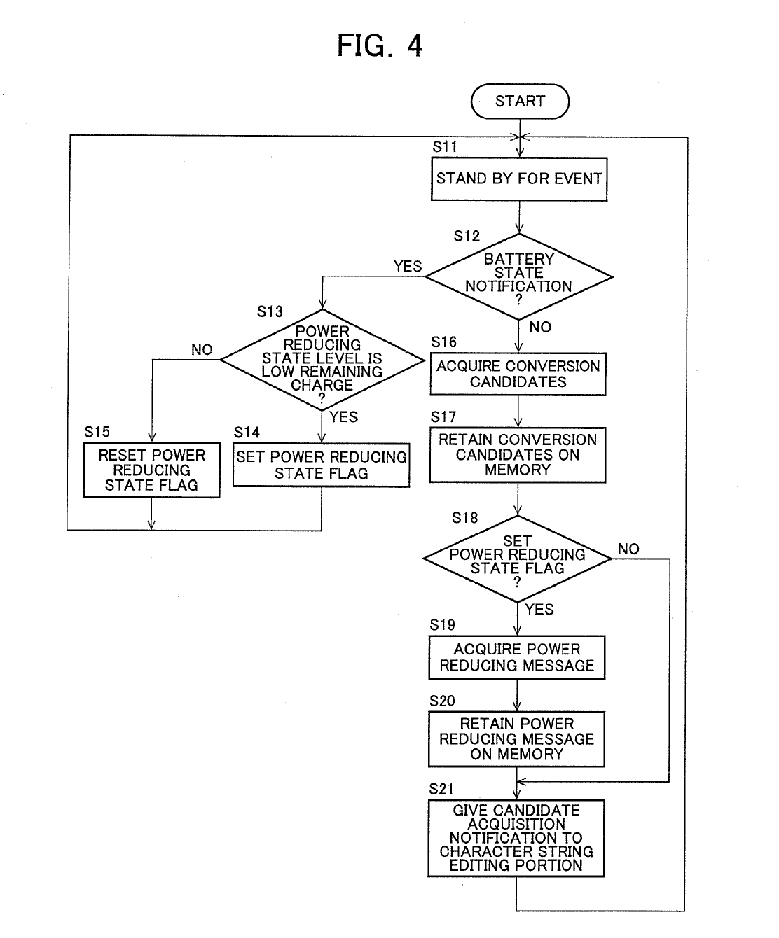

The process of acquiring a power reducing message by the predictive conversion controlling portion 26 will be described with reference to FIGS. 2 to 4. FIG. 3 is a flowchart of a process of the remaining battery charge determining portion 25. FIG. 4 is a flowchart of a process of the predictive conversion controlling portion 26.

A process flow of the remaining battery charge determining portion 25 will be described with reference to FIG. 3. When activated, the remaining battery charge determining portion 25 activates a timer (step S1) and enters an event waiting state (step S2).

When an event is generated, the remaining battery charge determining portion 25 determines whether the event is either an expiration event of the timer activated by the remaining battery charge determining portion 25 or a notification event from the remaining battery charge measuring portion 24 (step S3) and if the event corresponds to either event, the remaining battery charge determining portion 25 acquires a remaining battery charge level from the RAM 19 (step S4) and goes to step S5. The remaining battery charge level is a value measured by the remaining battery charge measuring portion 24 and stored on the RAM 19.

At step S3, if the generated event is neither the timer expiration event nor the notification event from the remaining battery charge measuring portion 24, the remaining battery charge determining portion 25 enters the event waiting state again (step S2).

At step S5, it is determined whether a remaining battery charge is equal to or less than the first prescribed value. If the remaining battery charge is equal to or less than the first prescribed value, the remaining battery charge determining portion 25 sets a power reducing state level of a power reducing state notification to the low remaining charge (step S6), gives the power reducing state notification to the predictive conversion controlling portion 26 (step S7), activates the timer again (step S1), and returns to the event waiting state (step S2).

At step S5, if the remaining battery charge is greater than the first prescribed value, the remaining battery charge determining portion 25 does nothing and activates the timer again (step S1) and returns to the event waiting state (step S2).

A process flow of the predictive conversion controlling portion 26 will be described with reference to FIG. 4. When activated, the predictive conversion controlling portion 26 enters an event waiting state of waiting for a character input notification event from the character string editing portion 23 and a battery state notification event from the remaining battery charge determining portion 25 (step S11). When an event is generated, the predictive conversion controlling portion 26 determines whether the event is the battery state notification event (step S12).

At step S12, if the event is the battery state notification event from the remaining battery charge determining portion 25, the predictive conversion controlling portion 26 goes to step S13 to determine whether a power reducing state level is the low remaining charge (step S13). If the power reducing state level is the low remaining charge, the predictive conversion controlling portion 26 sets a power reducing state flag on the RAM 19 (step S14) and enters the event waiting state again (step S11). Afterward, the predictive conversion controlling portion 26 determines that the battery remains equal to or less than a first predetermined value until the power reducing state flag is reset, and executes a process of adding a power reducing message to conversion candidates during document editing.

At step S13, if the power reducing state level is not the low remaining charge, i.e., if a remaining battery charge is greater than the first prescribed value, the power reducing state flag is reset (step S15). In this case, the predictive conversion controlling portion 26 determines that the battery is greater than the first predetermined value, i.e., a sufficient remaining battery charge exists for creating and transmitting a mail, and adds no power reducing message to conversion candidates during document editing.

At step S12, if the event is not the battery state notification event, i.e., is the character input notification event, the process goes to step S16. When receiving the character information notification, the predictive conversion controlling portion 26 acquires conversion candidates corresponding to the character information from the kana-kanji conversion dictionary 32 (step S16), retains the conversion candidates on the RAM 19 (step S17), and goes to step S18.

At step S18, it is determined whether the power reducing state flag is set. If the power reducing state flag is set, the predictive conversion controlling portion 26 acquires a power reducing message from the power reducing message dictionary 33 (step S19), adds the power reducing message such that the power reducing message is retained as a first candidate on the RAM 19 retaining the earlier conversion candidates (step S20), gives a candidate acquisition notification to the character string editing portion 23 (step S21), and returns to the event waiting again (step S21).

If the power reducing state flag is not set at step S18, the predictive conversion controlling portion 26 gives the candidate acquisition notification to the character string editing portion 23 (step S21) and returns to the event waiting again (step S21).

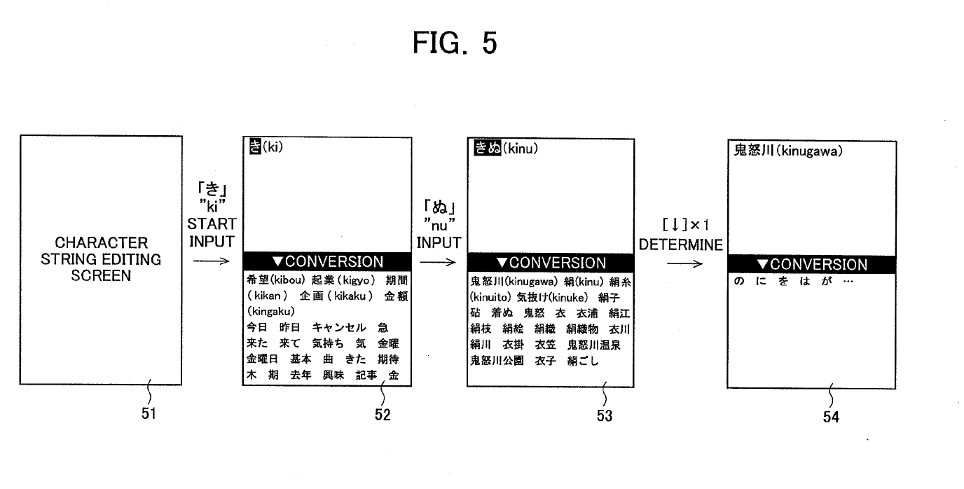

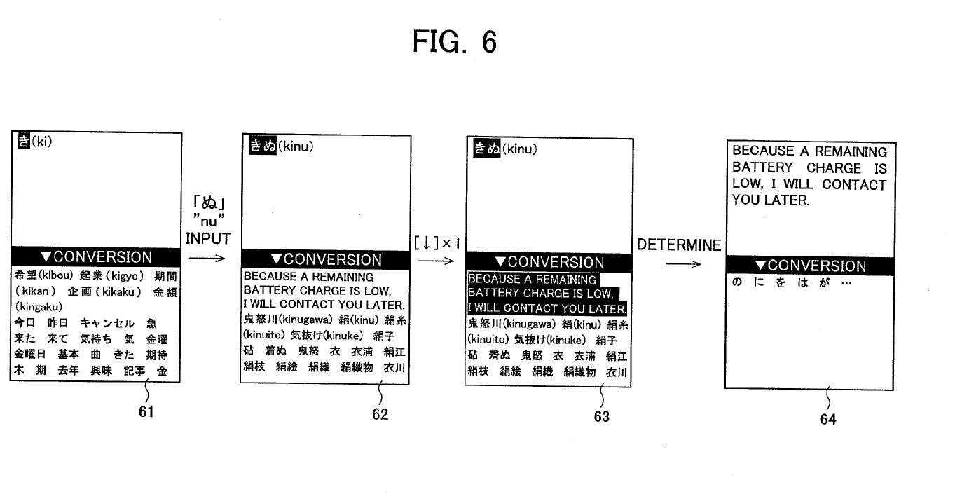

Description will be made of the case of a remaining battery charge greater than the first prescribed value, i.e., the case of the absence of the power reducing state, and the case of a remaining battery charge equal to or less than the first prescribed value, i.e., the case of the power reducing state, using the display on the displaying portion 12 with reference to FIGS. 1 to 6. FIG. 5 is a screen transition diagram when a remaining battery charge is greater than the first prescribed value. FIG. 6 is a screen transition diagram when a battery is in the power reducing state.

First, the case of a remaining battery charge greater than the first prescribed value will be described. A screen 51 of FIG. 5 depicts the displaying portion 12 displayed by the character string editing portion 23. In this description, the case of inputting “Ki-Nu-Gawa” is taken as an example. First, “ki” is input by the input portion 11 to the character string editing portion 23.

In this case, a character input notification event is generated in the predictive conversion controlling portion 26 (step S11) and the process goes to step S12. At step S12, it is determined that the generated event is not the battery state notification event and the process goes to step S16. At step S16, conversion candidates “Ki-Bou, Ki-Gyou, Ki-Kan . . . ” corresponding to the input information, i.e., “ki”, are acquired. The information is retained on the RAM 19 (step S17) and the process goes to step S18. At step S18, the power reducing state does not exist and, therefore, the process goes to step S21. At step S21, the candidate acquisition notification is given to the character string editing portion 23.

When receiving the candidate acquisition notification, the character string editing portion 23 displays the conversion candidates retained on the RAM 19 in the conversion candidate displaying area 12B of the displaying portion as depicted in a screen 52.

When “nu” is subsequently input by the input portion 11 to the character string editing portion 23, the same process is executed to display conversion candidates “Ki-Nu-Gawa, Kinu, Ki-Nu-ke . . . ” corresponding to “ki-nu” in the conversion candidate displaying area 12B as depicted in a screen 53. When “Ki-Nu-Gawa” is selected with the selecting keys 11B from the conversion candidates and the enter key 11C is pressed down, “Ki-Nu-Gawa” is confirmed. Subsequently, as depicted in a screen 54, the predictive conversion controlling portion 26 displays characters predicted to follow the confirmed input information, i.e., “Ki-Nu-Gawa”, on the displaying portion 12.

The case of the battery turning to the power reducing state during character editing will then be described. A screen 61 of FIG. 6 represents a state when “ki” is input to the character string editing portion 23 and the conversion candidates “Ki-Bou, Ki-Gyou, Ki-Kan . . . ” corresponding to “ki” are displayed in the conversion candidate displaying area 12B. It is assumed that the battery turns to the power reducing state at this point.

When the battery turns to the power reducing state, if “nu” is input by the input portion 11 to the character string editing portion 23, a character input notification event is generated in the predictive conversion controlling portion 26 (step S11); it is determined that this is not the battery state notification (step S12); and the process goes to step S16.

At step S16, the conversion candidates “Ki-Nu-Gawa, Kinu, Kinu-ito . . . ” corresponding to the input information, i.e., “ki-nu”, are acquired. These conversion candidates are retained on the RAM 19 (step S17) and the process goes to step S18.

Subsequently, it is determined that the power reducing state exists (step S18) and a power reducing message “Because a remaining battery charge is low, I will contact you later.” is acquired from the power reducing message dictionary 33 (step S19). The power reducing message “Because a remaining battery charge is low, I will contact you later.” is added and retained on the RAM 19 retaining the earlier conversion candidates “Ki-Nu-Gawa, Kinu, Kinu-ito . . . ” such that the power reducing message is defined as the first candidate (step S20) and the candidate acquisition notification is given to the character string editing portion 23 (step S21).

When receiving the candidate acquisition notification, the character string editing portion 23 displays the conversion candidates in the conversion candidate displaying area 12B of the displaying portion 12 (62). Subsequently, the power reducing message “because a remaining battery charge is low, I will contact you later.” is selected with the selection keys 11B from the conversion candidates displayed in the conversion candidate displaying area 12B (63) and the enter key 11C is pressed down to confirm the power reducing message in the character displaying area 12A (64).

As a result, if the remaining battery charge becomes very small while a mail is created, the power reducing message is displayed in the conversion candidates. An operator can create a reply mail with simple operation by selecting the power reducing message.

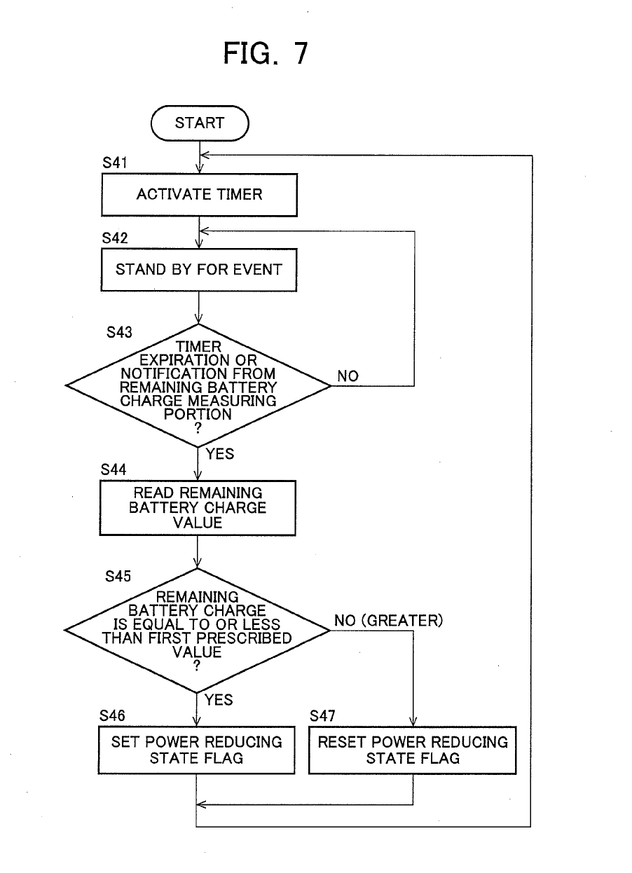

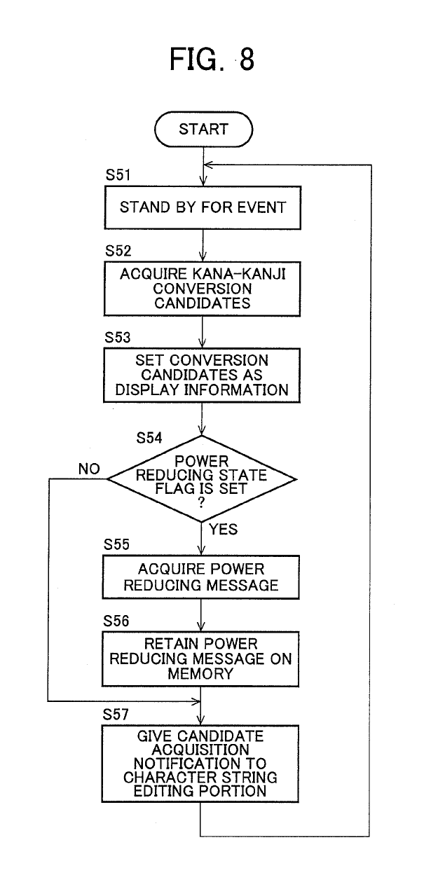

Other process patterns of the predictive conversion controlling portion 26 and the remaining battery charge determining portion 25 will be described with reference to FIGS. 2, 7, and 8. FIG. 7 is a flowchart of another process pattern of the remaining battery charge determining portion 25. FIG. 8 is a flowchart of another process pattern of the predictive conversion controlling portion 26.

The remaining battery charge determining portion 25 determining a remaining battery charge in a process pattern different from the remaining battery charge determining portion 25 described above will be described with reference to FIG. 7. When activated, the remaining battery charge determining portion 25 activates a timer (step S41) and enters an event waiting state (step S42).

When an event is generated, the remaining battery charge determining portion 25 determines whether the event is either an expiration event of the timer activated by the remaining battery charge determining portion 25 or a notification event from the remaining battery charge measuring portion 24 (step S43) and if the event corresponds to either event, the remaining battery charge determining portion 25 acquires a remaining battery charge level from the RAM 19 (step S44) and goes to step S45.

If the generated event is neither the timer expiration event nor the notification event from the remaining battery charge measuring portion 24, the remaining battery charge determining portion 25 enters the event waiting state again (step S42).

At step S45, it is determined whether a remaining battery charge is equal to or less than the first prescribed value. If the remaining battery charge is equal to or less than the first prescribed value, the remaining battery charge determining portion 25 sets a power reducing state flag on the RAM 19 (step S46), activates the timer again (step S41), and returns to the event waiting state again (step S42).

At step S45, if the remaining battery charge is greater than the first prescribed value, the remaining battery charge determining portion 25 resets the power reducing state flag (step S45), activates the timer (step S41), and returns to the event waiting state again (step S42).

The predictive conversion controlling portion 26 determining a remaining battery charge in a process pattern different from the predictive conversion controlling portion 26 described above will be described with reference to FIG. 8. When activated, the predictive conversion controlling portion 26 enters an event waiting state of waiting for a character input notification event from the character string editing portion 23 (step S51). When the character input notification event is generated, the predictive conversion controlling portion 26 acquires conversion candidates corresponding to the input information from the kana-kanji conversion dictionary 32 (step S52), retains the conversion candidates on the RAM 19 (step S53), and goes to step S54.

At step S54, it is determined whether the power reducing state flag is set. If the power reducing state flag is set, the predictive conversion controlling portion 26 acquires a power reducing message from the power reducing message dictionary 33 (step S55), adds the power reducing message such that the power reducing message is retained as the first candidate on the RAM 19 retaining the earlier conversion candidates (step S56), gives a candidate acquisition notification to the character string editing portion 23 (step S57), and returns to the event waiting again (step S51).

If the power reducing state flag is not set at step S54, the predictive conversion controlling portion 26 gives the candidate acquisition notification to the character string editing portion 23 (step S57) and returns to the event waiting again (step S51).

### Second Embodiment

A second embodiment of the portable telephone 1 will hereinafter be described. FIGS. 1 and 2 are the same as the first embodiment.

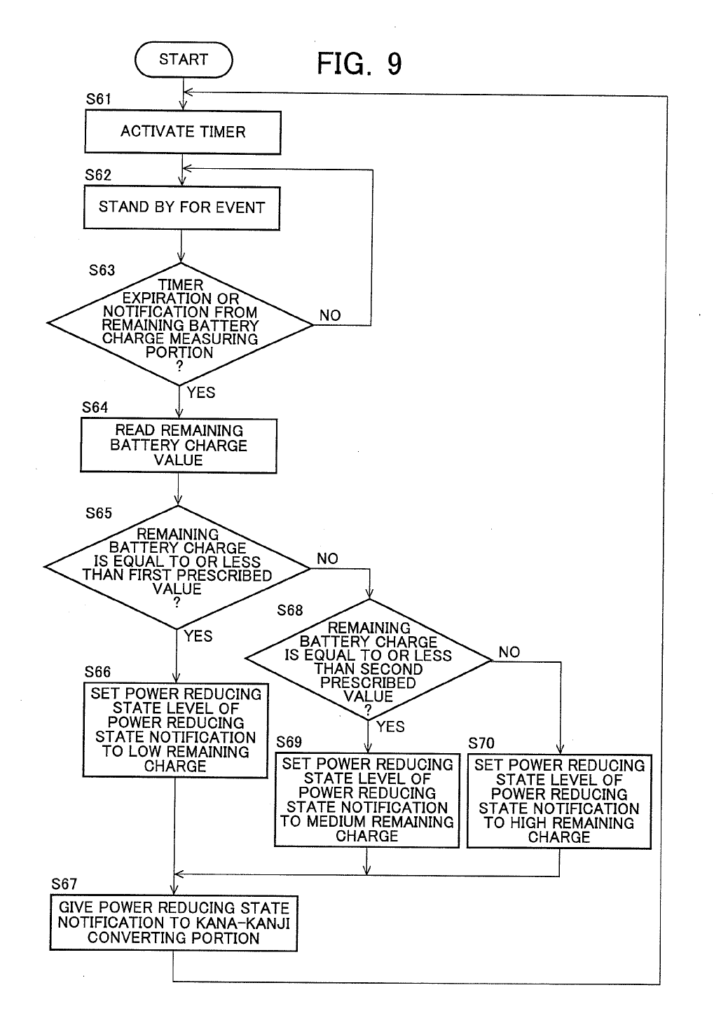

The remaining battery charge determining portion 25 of the second embodiment will be described with reference to FIG. 9. FIG. 9 is a flowchart of the remaining battery charge determining portion 25.

When activated, the remaining battery charge determining portion 25 activates a timer (step S61) and enters an event waiting state (step S62).

When an event is generated, the remaining battery charge determining portion 25 determines whether the event is either an expiration event of the timer or a notification event from the remaining battery charge measuring portion 24 (step S63) and if the event corresponds to either event, the remaining battery charge determining portion 25 acquires a remaining battery charge level from the RAM 19 (step S64) and goes to step S65.

At step S63, if the generated event is neither the timer expiration event nor the notification event from the remaining battery charge measuring portion 24, the remaining battery charge determining portion 25 enters the event waiting state again (step S62).

At step S65, it is determined whether a remaining battery charge is equal to or less than the first prescribed value. If the remaining battery charge is equal to or less than the first prescribed value, the remaining battery charge determining portion 25 sets a power reducing state level of a power reducing state notification to the low remaining charge (step S66), gives the power reducing state notification to the predictive conversion controlling portion 26 (step S67), activates the timer again (step S61), and returns to the event waiting state again (step S62).

At step S65, if the remaining battery charge is greater than the first prescribed value, the remaining battery charge determining portion 25 goes to step S68 to determine whether the remaining battery charge is equal to or less than the second prescribed value greater than the first prescribed value. If the remaining battery charge is equal to or less than the second prescribed value, the remaining battery charge determining portion 25 sets the power reducing state level of the power reducing state notification to the medium remaining charge (step S69), gives the power reducing state notification to the predictive conversion controlling portion 26 (step S67), activates the timer again (step S61), and returns to the event waiting state again (step S62).

At step S68, if the remaining battery charge is greater than the second prescribed value, the remaining battery charge determining portion 25 goes to step S70 to set the power reducing state level of the power reducing state notification to the high remaining charge. The remaining battery charge determining portion 25 then gives the power reducing state notification to the predictive conversion controlling portion 26 (step S67), activates the timer again (step S61), and returns to the event waiting state again (step S62).

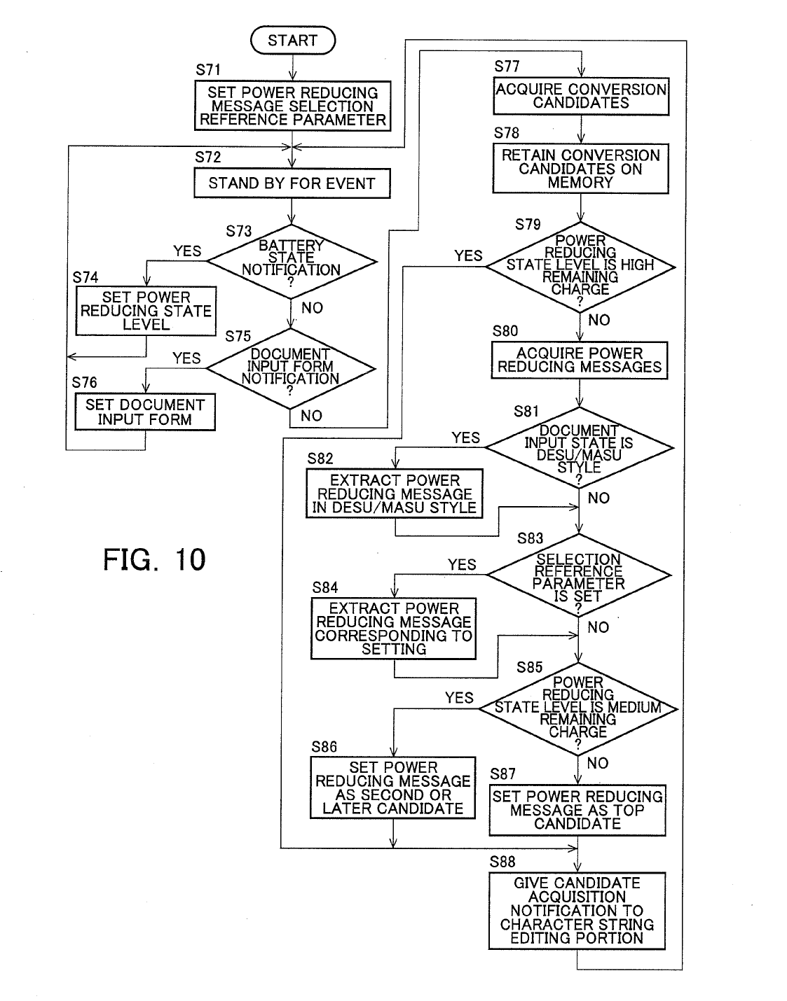

A flow of the predictive conversion controlling portion 26 of the second embodiment will be described with reference to FIGS. 2 and 10. FIG. 10 is a flowchart of the predictive conversion controlling portion 26.

If a power reducing message selection reference parameter is selected in the parameter setting portion 31, the predictive conversion controlling portion 26 acquires the power reducing message selection reference parameter from the parameter setting portion 31 to set the power reducing selection reference parameter (step S71). The predictive conversion controlling portion 26 goes to step S72.

At step S72, the predictive conversion controlling portion 26 enters an event waiting state of waiting for a character input notification event from the character string editing portion 23, a battery state notification event from the remaining battery charge determining portion 25, and a document input form notification event from the document analyzing portion 28 (step S72).

When an event is generated, the predictive conversion controlling portion 26 determines whether the event is the battery state notification event (step S73).

At step S73, if the event is the battery state notification event from the remaining battery charge determining portion 25, the predictive conversion controlling portion 26 sets the power reducing state level on the RAM 19 (step S74) and enters the event waiting state again (step S72). If the event is not the battery state notification event, the predictive conversion controlling portion 26 goes to step S75.

At step S75, it is determined whether the event is the document input form notification event. If the event is the document input form notification event, the predictive conversion controlling portion 26 sets a document input form (step S76) and enters the event waiting state again (step S72). If the document input form is set, a power reducing message suitable for a document being input is extracted from a plurality of power reducing messages.

If the event is not the document input form notification event, i.e., is the character input notification event, the predictive conversion controlling portion 26 goes to step S77.

At step S77, the predictive conversion controlling portion 26 acquires conversion candidates corresponding to the input character information from the kana-kanji conversion dictionary 32. The predictive conversion controlling portion 26 subsequently retains the conversion candidates on the RAM 19 (step S78) and goes to step S79.

At step S79, it is determined whether the power reducing state level is the high remaining charge. If the power reducing state level is the high remaining charge, the predictive conversion controlling portion 26 gives a candidate acquisition notification to the character string editing portion 23 so as to cause the character string editing portion 23 to display conversion candidates (step S88) and returns to the event waiting state again (step S72). Since the remaining battery charge is sufficient for creating and transmitting a mail in this flow, a power reducing message is not added to the conversion candidates.

At step S79, if the power reducing state level is not the high remaining charge, the predictive conversion controlling portion 26 acquires a plurality of power reducing message from the power reducing message dictionary 33 (step S80) and goes to step S81.

At step S81, it is determined whether the document input form is the “desu/masu style”. If the document input form is set to the “desu/masu style”, the predictive conversion controlling portion 26 extracts a power reducing message in the “desu/masu style” from a plurality of the power reducing messages acquired earlier (step S82) and goes to step S83.

At step S81, if the document input form is not set to the “desu/masu style”, the predictive conversion controlling portion 26 does not execute the process of extracting a power reducing message in the “desu/masu style” from a plurality of the power reducing messages and goes to step S83.

At step S83, it is determined whether the power reducing message selection reference parameter is set. If the selection reference parameter is set, the predictive conversion controlling portion 26 extracts a power reducing message corresponding to the power reducing message selection reference parameter from a plurality of the power reducing messages (step S84) and goes to step S85.

At step S83, if the power reducing message selection reference parameter is not set, the predictive conversion controlling portion 26 directly goes to step S85.

The process of extracting a power reducing message corresponding to the power reducing message selection reference parameter from a plurality of the power reducing messages will be described in detail later.

At step S85, it is determined whether the power reducing state level is the medium remaining charge. If the power reducing state level is the medium remaining charge, the power reducing message is added to the conversion candidates acquired earlier and is retained on the RAM 19 such that the power reducing message is defined as a second or later candidate (step S86) and a candidate acquisition notification is given to the character string editing portion 23 (step S88). In this case, the power reducing message is defined as the second or later candidate rather than the first candidate because a short text can be created.

If the power reducing state level is not the medium remaining charge, the power reducing state level is the low remaining charge and, therefore, the power reducing message is added to the conversion candidates acquired earlier and is retained on the RAM 19 such that the power reducing message is defined as the top candidate (step S86) and a candidate acquisition notification is given to the character string editing portion 23 (step S88).

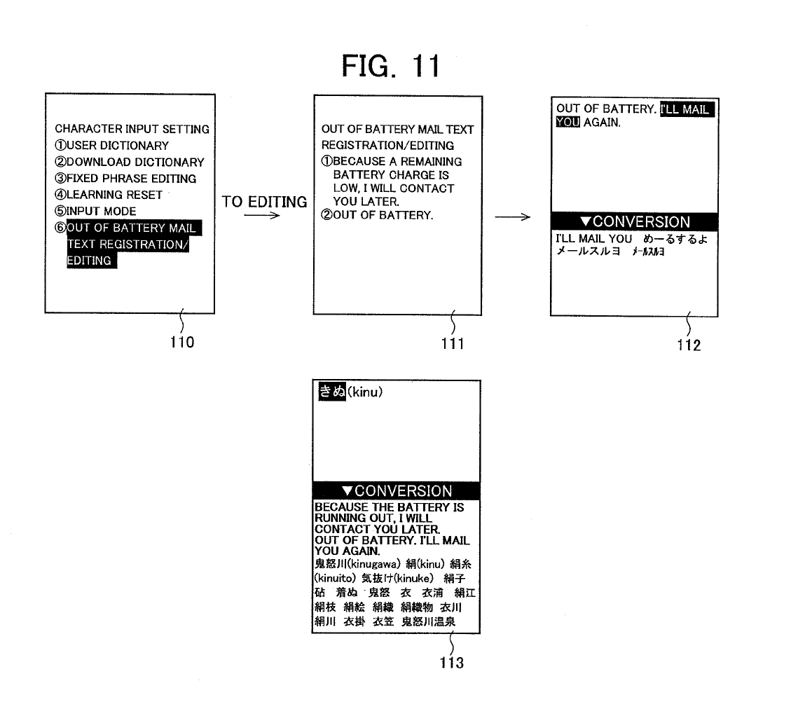

A registering method of a power reducing message will be described with reference to FIGS. 2 and 11. FIG. 11 is a screen transition diagram of a process of registering a plurality of power reducing messages.

The power reducing messages are registered by the power reducing message registering portion 27 to the power reducing message dictionary 33. The power reducing message registering portion 27 is activated by selecting “low battery mail text registration/editing” from a menu screen of the portable telephone 1 depicted in a screen 110, for example. As depicted in a screen 111, when activated, the power reducing message registering portion 27 displays a list of registered power reducing messages. If one message is selected from the list, the power reducing message can be edited as depicted in a screen 112. If a plurality of power reducing messages is registered as described above, a plurality of the power reducing messages is displayed as depicted in a screen 113 when the power reducing state level of the battery turns to the low remaining charge value while mail is created.

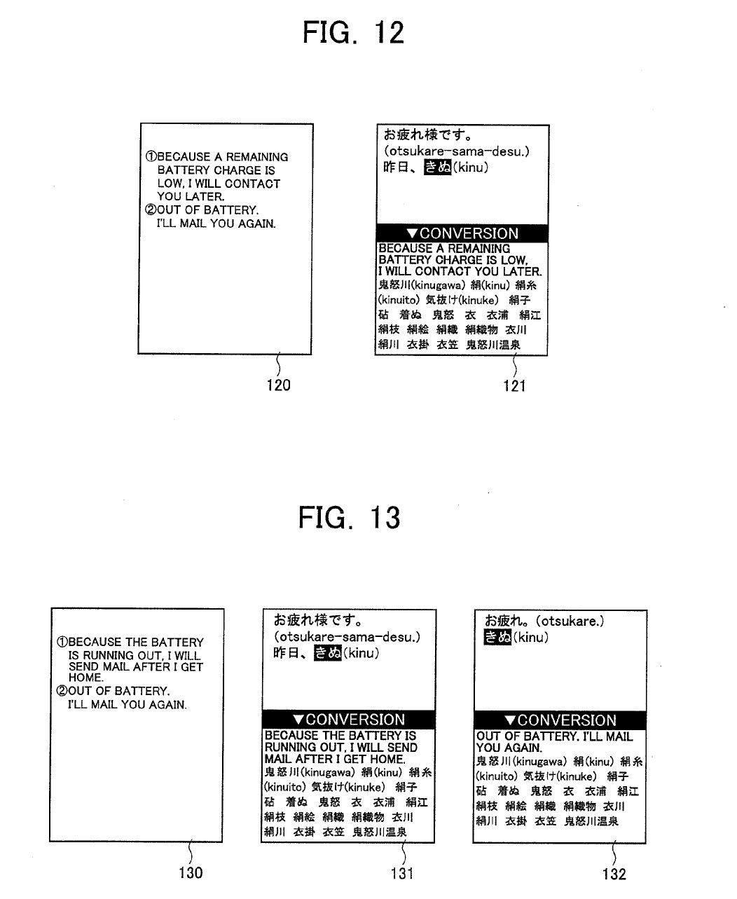

A process of extracting a power reducing message corresponding to a document input form from a plurality of power reducing messages will be described on the assumption that the battery state level is the low remaining charge and that the power reducing message selection reference parameter is not selected with reference to FIGS. 2, 10, and 12. FIG. 12 is a diagram of how the power reducing message corresponding to a document input form is displayed.

A screen 120 depicts how the registered power reducing messages are displayed on the displaying portion 12. Specifically, the power reducing message dictionary 33 has two registered power reducing messages “Because a remaining battery charge is low, I will contact you later.” and “Out of battery. I'll mail you again.”

If a sentence in the desu/masu style, for example, “otsukare-sama-desu.” is input in the character string editing portion 23, the document analyzing portion 28 gives a document input form notification to the predictive conversion controlling portion 26 to indicate that a document input state is the desu/masu style state.

The predictive conversion controlling portion 26 goes through step S72, step S73, and step S75 to step S76, sets the document input form to the “desu/masu style” at step S76, and returns to the event waiting again (step S72).

If the character input notification event is generated, the predictive conversion controlling portion 26 goes through step S72, step S73, and step S75 to step S77, acquires conversion candidates corresponding to the character input at step S77, and retains the conversion candidates on the RAM 19 at step S78. The predictive conversion controlling portion 26 goes through step S79, acquires the power reducing messages “Because a remaining battery charge is low, I will contact you later.” and “Out of battery. I'll mail you again.” at step S80, and goes to step S81.

At step S81, since the document input form is set to the desu/masu style, the process goes to step S82. At step S82, the desu/masu style message “Because a remaining battery charge is low, I will contact you later.” is extracted from the two power reducing messages “Because a remaining battery charge is low, I will contact you later.” and “Out of battery. I'll mail you again.” and the process goes to step S83.

Subsequently, the predictive conversion controlling portion 26 goes through step S83, step S85, step S87, and step S88 and returns to step S72. When the process as described above is executed, the display on the displaying portion 12 is as depicted in a screen 121.

A process of extracting a power reducing message corresponding to the power reducing message selection reference parameter from a plurality of power reducing messages will be described on the assumption that the battery state level is the low remaining charge and that the document input form is not set with reference to FIGS. 2, 10, and 13. FIG. 13 is a diagram of how the power reducing message corresponding to the power reducing message selection reference parameter is displayed. Description will be made of the case that “business” is set as a selection reference setting.

A screen 130 represents how the registered power reducing messages are displayed on the displaying portion 12. Specifically, the power reducing message dictionary 33 has registered messages “Because the battery is running out, I will send mail after I get home.” and “Out of battery. I'll mail you again.”

If the character input notification event is generated, the predictive conversion controlling portion 26 goes through step S72, step S73, and step S75 to step S77, acquires conversion candidates corresponding to the character input at step S77, and retains the conversion candidates on the RAM 19 at step S78. The predictive conversion controlling portion 26 goes through step S79, acquires the power reducing messages described above at step S80, and goes to step S81. At step S81, since the document input form is not set, the process goes to step S83.

At step S83, since the selection reference parameter is set, the process goes to step S84.

Subsequently, at step S84, if “business” is set as the selection reference parameter, the predictive conversion controlling portion 26 acquires terms related to “business”, i.e., “desu./masu./otsukare-sama/gokurou-sama . . . ” from the term dictionary and extracts a power reducing message including these terms from a plurality of the power reducing messages acquired at step S80. Specifically, “Because the battery is running out, I will send mail after I get home.” is extracted and the process goes to step S83. The process then goes through step S85, step S87, and step S88 and returns to step S72 again. When the process as described above is executed, the display on the displaying portion 12 is as depicted in a screen 131.

If “friend” is set as the selection reference parameter, the predictive conversion controlling portion 26 acquires terms related to “friend”, i.e., “da./yo./ . . . ” from the term dictionary at step S84 and extracts a power reducing message including these terms from a plurality of the power reducing messages acquired at step S80. Specifically, “Out of battery. I'll mail you again.” is extracted and displayed on the displaying portion 12 as depicted in 132.

The execution of the process described above allows an operator to save the effort of selecting a power reducing message appropriate for the other party.

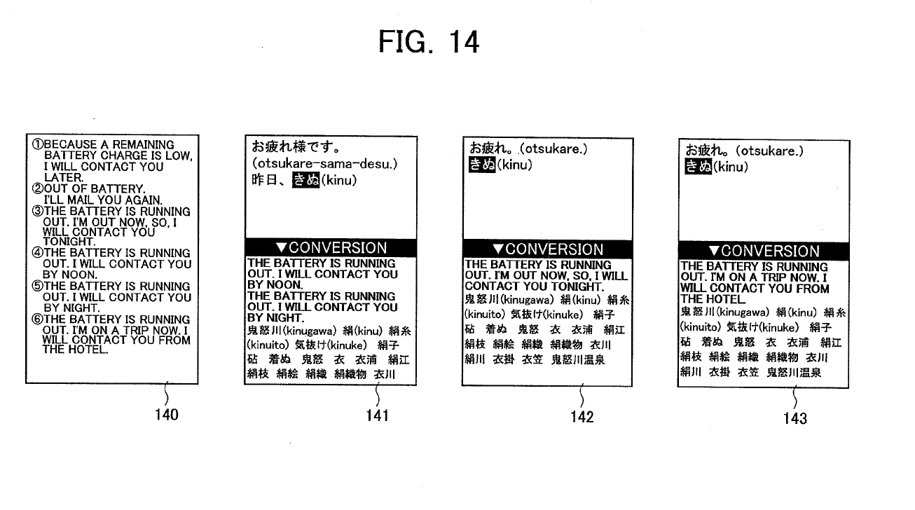

A process of extracting a power reducing message corresponding to a power reducing message selection reference parameter from a plurality of power reducing messages will be described on the assumption that the battery state is the low level and that the document input form is set to the desu/masu style with reference to FIGS. 2, 10, and 14.

Description will be made case-by-case on the assumption that one of “time”, “outgoing”, and “travel” is set as the selection reference setting.

A screen 140 depicts how the registered power reducing messages are displayed on the displaying portion 12. Specifically, the power reducing message dictionary 33 has the following registered messages:
“Because a remaining battery charge is low, I will contact you later”;
“Out of battery. I'll mail you again”;
“The battery is running out. I'm out now, so, I will contact you tonight”;
“The battery is running out. I will contact you by noon”;
“The battery is running out. I will contact you by night”; and
“The battery is running out. I'm on a trip now. I will contact you from the hotel”.

If the character input notification event is generated, the predictive conversion controlling portion 26 goes through step S72, step S73, and step S75 to step S77, acquires conversion candidates corresponding to the character input at step S77, and retains the conversion candidates on the RAM 19 at step S78. The predictive conversion controlling portion 26 goes through step S79, acquires the power reducing messages described above at step S80, and goes to step S81.

Since the document input form is the desu/masu style, the following desu/masu style messages are selected from the plurality of the power reducing messages:
“Because a remaining battery charge is low, I will contact you later”;
“The battery is running out. I'm out now, so, I will contact you tonight”;
“The battery is running out. I will contact you by noon”;
“The battery is running out. I will contact you by night”; and
“The battery is running out. I'm on a trip now. I will contact you from the hotel”. The process goes to step S83.

At step S83, since the selection reference parameter is set, the process goes to step S84.

Description will hereinafter be made case-by-case on the assumption that “time”, “outgoing”, or “travel” is set as the selection reference setting.

The case of “time” set as the selection reference will be described. At step S84, if “time” is set as the selection reference parameter, terms related to “time”, i.e., “morning/daytime/night/noon/hour/minute . . . ” are acquired from the term dictionary and a power reducing message including these terms is extracted from a plurality of the power reducing messages extracted at step S82. Specifically, “The battery is running out. I will contact you by noon” and “The battery is running out. I will contact you by night” are extracted and the process goes to step S83. The process then goes through step S85, step S87, and step S88 and returns to step S72 again. When the process as described above is executed, the display on the displaying portion 12 is as depicted in a screen 141.

The case of “outgoing” set as the selection reference will be described. At step S84, if “outgoing” is set as the selection reference parameter, terms related to “outgoing”, i.e., “out/destination/go home directly . . . ” are acquired from the term dictionary and a power reducing message including these terms is extracted from a plurality of the power reducing messages extracted at step S82. Specifically, “The battery is running out. I'm out now, so, I will contact you tonight” is extracted and the process goes to step S83. The process then goes through step S85, step S87, and step S88 and returns to step S72 again. When the process as described above is executed, the display on the displaying portion 12 is as depicted in a screen 142.

The case of “travel” set as the selection reference will lastly be described. At step S84, if “travel” is set as the selection reference parameter, terms related to “travel”, i.e., “trip/vacation/vacances/hotel/Ryokan . . . ” are acquired from the term dictionary and a power reducing message including these terms is extracted from a plurality of the power reducing messages extracted at step S82. Specifically, “The battery is running out. I'm on a trip now. I will contact you from the hotel” is extracted and the process goes to step S83. The process then goes through step S85, step S87, and step S88 and returns to step S72 again. When the process as described above is executed, the display on the displaying portion 12 is as depicted in a screen 143.

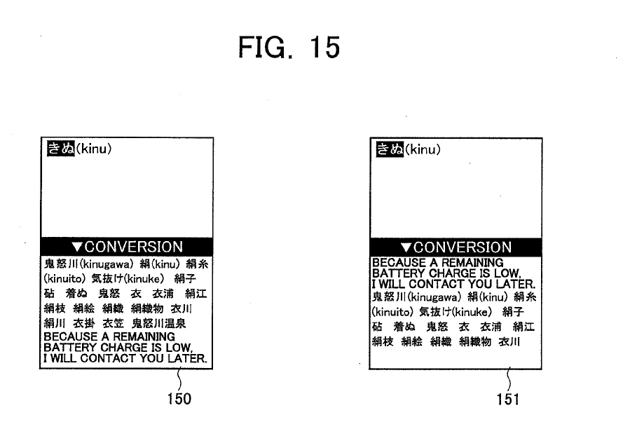

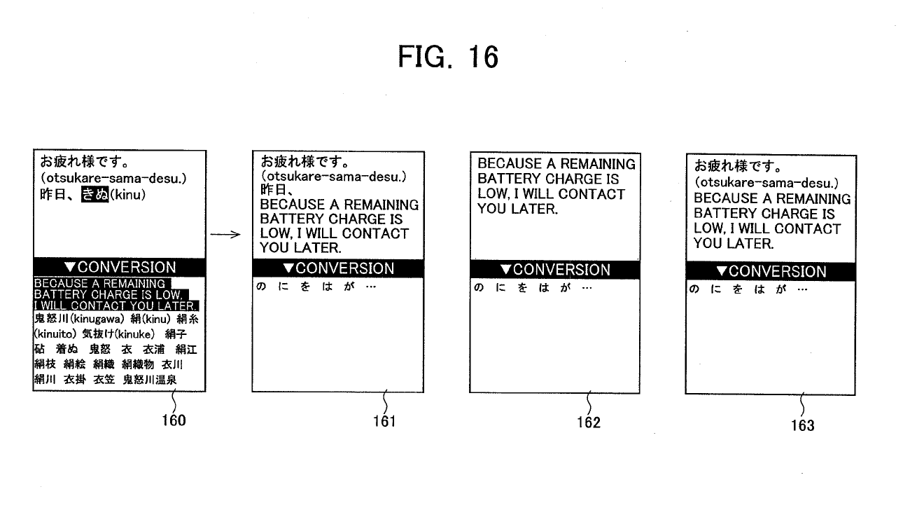

The case of displaying a power reducing message at a candidate position changed depending on a remaining battery charge will be described with reference to FIGS. 1, 10, and 15. FIG. 15 is a diagram of how a power reducing message is displayed at a candidate position changed depending on a remaining battery charge.

At step S85, if the power reducing state level is the medium remaining charge, the power reducing message is set as a second or later candidate (step S86); a candidate acquisition notification is given to the character string editing portion 23 (step S88); and the character string editing portion 23 displays a screen as depicted in a screen 150. In the screen 150, the power reducing message is adjusted to be displayed at the end of the conversion candidate displaying area 12B.

If the power reducing state level is the medium remaining charge, it is not necessary to select the power reducing message in haste and, therefore, the power reducing message is set as the last candidate. In this case, since the power reducing message is displayed as a candidate, an operator can know that it is difficult to create a long mail.

At step S85, if the power reducing state level is not the medium remaining charge, i.e., is the small remaining charge, the power reducing message is set as the top candidate (step S87); a candidate acquisition notification is given to the character string editing portion 23 (step S88); and the character string editing portion 23 displays a screen as depicted in a screen 151.

If the power reducing state level is the small remaining charge, a time available for creating mail is shorter as compared to the case of the medium remaining charge and, therefore, the power reducing message is displayed at the top of a candidate field, i.e., a quickly selectable position.

By displaying the power reducing message at a display position changed depending on a remaining battery charge, an operator can create a mail corresponding to a remaining battery charge.

An adjustment process of a mail body text after selecting a power reducing message will be described with reference to FIGS. 2 and 16. FIG. 16 is a diagram of how the adjustment process of a mail body text is executed.

For example, if a power reducing message is selected in the case as depicted in a screen 160, the power reducing message is directly inserted into a text being created as depicted in a screen 161 and the content of a mail may become inconsistent.

Therefore, if the power reducing message is selected, the character string editing portion 23 may delete the mail body text from the start to an unfinished input position such that the power reducing message is displayed as depicted in a screen 162. Alternatively, the document analyzing portion 28 may be driven to search for the last comma in a sentence being input so as to delete a portion of the sentence after the last comma and display the power reducing message as depicted in a screen 163. By executing the process as described above, the main body of a mail can be created as a consistent text having a meaning.

Although the process of extracting a power reducing message corresponding to the power reducing message selection reference parameter from a plurality of power reducing messages is described as a method in which terms related to the selection reference parameter are acquired so as to acquire a power reducing message including the terms, this is not a limitation. For example, the power reducing messages may be registered in correlation with a selection parameter such that when the selection reference parameter is set, the predictive conversion controlling portion 26 extracts the power reducing message correlated with the selection reference parameter.

### EXPLANATIONS OF LETTERS OR NUMERALS

1 . . . portable telephone; 11 . . . input portion; 11A . . . character key; 11B . . . selection key; 11C . . . enter key; 12 . . . displaying portion; 12A . . . character displaying area; 12B . . . conversion candidate displaying area; 13 . . . microphone; 14 . . . speaker; 15 . . . CPU; 16 . . . storage portion; 17 . . . battery; 18 . . . ROM; 19 . . . RAM; 21 . . . communicating portion; 22 . . . mail portion; 23 . . . character string editing portion; 24 . . . remaining battery charge measuring portion; 25 . . . remaining battery charge determining portion; 26 . . . predictive conversion controlling portion; 27 . . . power reducing message registering portion; 28 . . . document analyzing portion; 29 . . . address book setting portion; 30 . . . schedule book setting portion; 31 . . . parameter setting portion; 32 . . . kana-kanji conversion dictionary; and 33 . . . power reducing message dictionary.

1. A communication terminal apparatus comprising:
a communicating portion for sending/receiving a mail;
a displaying portion;
a storage portion that a preliminarily created power reducing message registered;
a character string editing portion for displaying characters input by an input portion and conversion candidates of the characters on the displaying portion;
a predictive conversion controlling portion for acquiring conversion candidates corresponding to characters input to the character string editing portion; and
a remaining battery charge determining portion for determining a state of a remaining battery charge, wherein
the predictive conversion controlling portion acquires and adds the power reducing message from the storage portion to conversion candidates if the remaining battery charge determining portion determines that a remaining battery charge level is equal to or less than a first prescribed value.

2. The communication terminal apparatus as defined in claim 1, wherein a plurality of the power reducing messages is registered in the storage portion, and the predictive conversion controlling portion acquires and adds a plurality of power reducing messages to conversion candidates.

3. The communication terminal apparatus as defined in claim 1, wherein when an operator selects and determines the power reducing message from the conversion candidates, the character string editing portion deletes characters that are being edited in the character string editing portion and displays the power reducing message on the displaying portion.

4. The communication terminal apparatus as defined in claim 1, wherein the remaining battery charge determining portion determines that it is low remaining charge if the remaining battery charge level is equal to or lower than the first prescribed value and determines that it is medium remaining charge if the remaining battery charge level is greater than the first prescribed value and equal to or less than a second prescribed value, and
the predictive conversion controlling portion defines the power reducing message as a first candidate of the conversion candidates if a remaining battery charge corresponds to the low remaining charge and defines the power reducing message as a second or later candidate of the conversion candidates if a remaining battery charge corresponds to the medium remaining charge.

5. The communication terminal apparatus as defined in claim 2, further comprising a document analyzing portion for analyzing a text that is being edited in the character string editing portion, wherein
the document analyzing portion analyzes a sentence form from the end of a sentence in a document displayed in the character string editing portion and notifies the predictive conversion controlling portion of an analysis result as a document input form, and
when the document input form is notified, the predictive conversion controlling portion acquires the power reducing message corresponding to the document input form.

6-9. (canceled)

10. The communication terminal apparatus as defined in claim 3, further comprising a document analyzing portion for analyzing a text that is being edited in the character string editing portion, wherein
the document analyzing portion analyzes a sentence form from the end of a sentence in a document displayed in the character string editing portion and notifies the predictive conversion controlling portion of an analysis result as a document input form, and
when the document input form is notified, the predictive conversion controlling portion acquires the power reducing message corresponding to the document input form.

11. The communication terminal apparatus as defined in claim 4, further comprising a document analyzing portion for analyzing a text that is being edited in the character string editing portion, wherein
the document analyzing portion analyzes a sentence form from the end of a sentence in a document displayed in the character string editing portion and notifies the predictive conversion controlling portion of an analysis result as a document input form, and
when the document input form is notified, the predictive conversion controlling portion acquires the power reducing message corresponding to the document input form.

12. The communication terminal apparatus as defined in claim 2, further comprising
a parameter setting portion for setting a selection reference parameter acting as a selection reference when a power reducing message is extracted from a plurality of power reducing messages, and
a term dictionary for managing terms related to the selection reference parameter, wherein
if the selection reference parameter is set, the predictive conversion controlling portion acquires terms related to the selection reference parameter from the term dictionary and acquires a power reducing message including the terms.

13. The communication terminal apparatus as defined in claim 3, further comprising
a parameter setting portion for setting a selection reference parameter acting as a selection reference when a power reducing message is extracted from a plurality of power reducing messages, and
a term dictionary for managing terms related to the selection reference parameter, wherein
if the selection reference parameter is set, the predictive conversion controlling portion acquires terms related to the selection reference parameter from the term dictionary and acquires a power reducing message including the terms.

14. The communication terminal apparatus as defined in claim 4, further comprising
a parameter setting portion for setting a selection reference parameter acting as a selection reference when a power reducing message is extracted from a plurality of power reducing messages, and
a term dictionary for managing terms related to the selection reference parameter, wherein
if the selection reference parameter is set, the predictive conversion controlling portion acquires terms related to the selection reference parameter from the term dictionary and acquires a power reducing message including the terms.

15. The communication terminal apparatus as defined in claim 5, further comprising
a parameter setting portion for setting a selection reference parameter acting as a selection reference when a power reducing message is extracted from a plurality of power reducing messages, and
a term dictionary for managing terms related to the selection reference parameter, wherein
if the selection reference parameter is set, the predictive conversion controlling portion acquires terms related to the selection reference parameter from the term dictionary and acquires a power reducing message including the terms.

16. The communication terminal apparatus as defined in claim 10, further comprising
a parameter setting portion for setting a selection reference parameter acting as a selection reference when a power reducing message is extracted from a plurality of power reducing messages, and
a term dictionary for managing terms related to the selection reference parameter, wherein
if the selection reference parameter is set, the predictive conversion controlling portion acquires terms related to the selection reference parameter from the term dictionary and acquires a power reducing message including the terms.

17. The communication terminal apparatus as defined in claim 11, further comprising
a parameter setting portion for setting a selection reference parameter acting as a selection reference when a power reducing message is extracted from a plurality of power reducing messages, and
a term dictionary for managing terms related to the selection reference parameter, wherein
if the selection reference parameter is set, the predictive conversion controlling portion acquires terms related to the selection reference parameter from the term dictionary and acquires a power reducing message including the terms.

18. The communication terminal apparatus as defined in claim 2, further comprising
a parameter setting portion for setting a selection reference parameter acting as a selection reference when a power reducing message is extracted from a plurality of power reducing messages, wherein
the power reducing messages are registered in the storage portion in correlation with the selection reference parameter, and
if the selection reference parameter is set, the predictive conversion controlling portion acquires a power reducing message correlated with the selection reference parameter.

19. The communication terminal apparatus as defined in claim 3, further comprising
a parameter setting portion for setting a selection reference parameter acting as a selection reference when a power reducing message is extracted from a plurality of power reducing messages, wherein
the power reducing messages are registered in the storage portion in correlation with the selection reference parameter, and
if the selection reference parameter is set, the predictive conversion controlling portion acquires a power reducing message correlated with the selection reference parameter.

20. The communication terminal apparatus as defined in claim 4, further comprising
a parameter setting portion for setting a selection reference parameter acting as a selection reference when a power reducing message is extracted from a plurality of power reducing messages, wherein
the power reducing messages are registered in the storage portion in correlation with the selection reference parameter, and
if the selection reference parameter is set, the predictive conversion controlling portion acquires a power reducing message correlated with the selection reference parameter.

21. The communication terminal apparatus as defined in claim 5, further comprising
a parameter setting portion for setting a selection reference parameter acting as a selection reference when a power reducing message is extracted from a plurality of power reducing messages, wherein
the power reducing messages are registered in the storage portion in correlation with the selection reference parameter, and
if the selection reference parameter is set, the predictive conversion controlling portion acquires a power reducing message correlated with the selection reference parameter.

22. The communication terminal apparatus as defined in claim 10, further comprising
a parameter setting portion for setting a selection reference parameter acting as a selection reference when a power reducing message is extracted from a plurality of power reducing messages, wherein
the power reducing messages are registered in the storage portion in correlation with the selection reference parameter, and
if the selection reference parameter is set, the predictive conversion controlling portion acquires a power reducing message correlated with the selection reference parameter.

23. An email creating method used in a communication terminal apparatus comprising:
a communicating portion for sending/receiving a mail;
a displaying portion;
a storage portion that a preliminarily created power reducing message registered;
a character string editing portion for displaying characters input by an input portion and conversion candidates of the characters on the displaying portion;
a predictive conversion controlling portion for acquiring conversion candidates corresponding to characters input to the character string editing portion; and
a remaining battery charge determining portion for determining a state of a remaining battery charge, wherein
the predictive conversion controlling portion acquires and adds the power reducing message from the storage portion to conversion candidates if the remaining battery charge determining portion determines that a remaining battery charge level is lower than a prescribed value.

24. A computer readable recording medium recording an email creating program run on a computer to implement the email creating method as defined in claim 23.
